(19) United States
(12) Patent Application Publication
(10) Pub. No.: US 2020/0308022 A1
(43) Pub. Date: Oct. 1, 2020

(54) PHOTOTHERMAL DESALINATION SYSTEM

(71) Applicant: David O'Laighin, Maricopa, AZ (US)

(72) Inventor: David O'Laighin, Maricopa, AZ (US)

(21) Appl. No.: 16/831,530

(22) Filed: Mar. 26, 2020

Related U.S. Application Data
(60) Provisional application No. 62/919,762, filed on Mar. 28, 2019.

(51) Int. Cl. C02F 1/14; C02F 1/04

(52) U.S. Cl. CPC C02F 1/14; B01D 5/006; C02F 1/045

(57) ABSTRACT

A photothermal desalination system includes a seawater harvester that harvests cold seawater from below the ocean thermocline. Heat transfer coils are filled with the cold seawater and steam from a steam generator (boiler) condenses upon interaction with the heat transfer coils to produce fresh water. To achieve a minimal environmental footprint, the steam generator produces steam from the harvested seawater using peanut oil that is heated to just below its smoke point. Heating the peanut oil can be accomplished using concentrated solar power. The peanut oil can be stored in insulated in-ground containers. In addition to using the steam to generate fresh water, some of the steam can be used to generate electricity which can be used to power various components of the system. Moreover, the system can produce other useful products from otherwise wasteful outputs, including biofuel and glycerin from peanut oil sludge and sea salt from brine water.

### CROSS-REFERENCE TO RELATED APPLICATIONS

This application claims the benefit of U.S. Provisional Application No. 62/919,762, filed on Mar. 28, 2019, the subject matter of which is incorporated herein by reference.

### TECHNICAL FIELD

The present disclosure relates generally to desalination systems, and, more particularly, to a photothermal desalination system.

### BACKGROUND

Currently the need for clean fresh water is exceeding the planet's capabilities in many regions of the globe. The bulk of the Earth's fresh water is located in areas inaccessible to the majority of persons living today. Only 7% of the water on Earth is fresh and of that, only 2% is easily accessible. Fresh water sources such as rivers, lakes, streams, and aquifers are often polluted or frequently dry up because of draught or overutilization. The United Nations reports that water is scarce for about 2.7 billion people, and 1.1 billion people have little or no access to clean fresh water.

At the same time, the planet's land masses are surrounded by a vast amount of sea water. Oceans account for about 71% of the Earth's surface area. The problem is that the oceans contain salt water that cannot be used for drinking and is unsuitable for most other purposes including farming Although there are known methods to desalinate salt water to obtain fresh water, these techniques are not generally economical.

Desalination has been around for thousands of years. Improvements in thermal desalination and seawater reverse-osmosis have made the process somewhat more promising. Yet, desalination is still relatively expensive since the energy required to remove salt and other minerals from sea water is too costly. This makes it particularly unfeasible in poorer areas of the world where fresh water is needed the most.

### SUMMARY

A photothermal desalination system includes a seawater harvester that harvests cold seawater from below the ocean thermocline. Heat transfer coils are filled with the cold seawater and steam from a steam generator (boiler) condenses upon interaction with the heat transfer coils to produce fresh water. To achieve a minimal environmental footprint, the steam generator produces steam from the harvested seawater using peanut oil that is heated to just below its smoke point. Heating the peanut oil can be accomplished using concentrated solar power. The peanut oil can be stored in insulated in-ground containers. In addition to using the steam to generate fresh water, some of the steam can be used to generate electricity which can be used to power various components of the system. Moreover, the system can produce other useful products from otherwise wasteful outputs, including biofuel and glycerin from peanut oil sludge and sea salt from brine water.

### BRIEF DESCRIPTION OF THE DRAWINGS

FIG. 1 is a process diagram illustrating a photothermal desalination system, according to an example embodiment of the disclosure.

### DETAILED DESCRIPTION OF EXAMPLE EMBODIMENTS

Example embodiments of the disclosure now will be described more fully hereinafter with reference to the accompanying drawings, in which example embodiments are shown. The concepts discussed herein may, however, be embodied in many different forms and should not be construed as limited to the example embodiments set forth herein; rather, these embodiments are provided so that this disclosure will be thorough and complete, and will fully convey the scope to those of ordinary skill in the art. Like numbers refer to like elements but not necessarily the same or identical elements throughout.

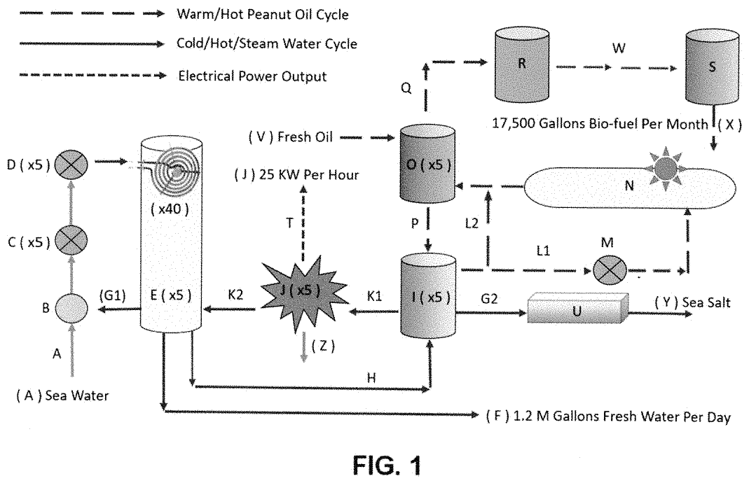

Referring to FIG. 1, a process diagram illustrating a photothermal desalination system 100, according to an example embodiment of the disclosure, is provided. In the following description, metrics and multiplicity numbers are merely exemplary. It is to be understood that the following example is not meant to be limiting, and that the desalination system disclosed herein is notable for being scalable.

The example photothermal desalination system 100 is comprised of the following components:

Filters B,

First stage pumps C (5×)

Second stage pumps D (5×),

Condensation towers E (5×) with heat exchanger spiral coils (40×),

Water boilers I (5×),

Steam powered electrical generators J (5×),

Oil pump M,

Solar heat concentrator array N,

Oil boilers O (5×),

Biofuel breeder R,

Biofuel storage tank S, and

Evaporative desalinator U.

The system inputs are:

Seawater A,

Peanut oil V, and

sunlight (not labeled).

The system outputs are:

Biofuel X,

Sea salt Y,

Waste water G1,

Condense water Z, and

Electric power J.

According to an embodiment of the disclosure, the example photothermal desalination system 100 operates as follows:

Seawater A is harvested from the deep ocean (below the ocean thermocline) which is on average at a depth of approximately 500 meters from the ocean surface, where the temperature is between 0-12° C. at all times and all latitudes. A filtration cage is abutting the 8-in approximate diameter flexible pipe line, which is connected to Filter B. From Filter B to Towers E, the seawater is pumped by five parallel coupled First stage pumps C first, and second, by five Second stage pumps D, ensuring about 1,000 gallon per minute flow rate at all times, while the system 100 is active. To ensure that flow rate, three pumps may suffice at each stage. The remaining two are preferably provided for redundancy to ensure continuous plant operation, even in emergencies or during pump servicing. The pumping height above ground can be about 50-ft, which is about the height of the Towers E.

The pumped lines can be interconnected, so the seawater inflow into each Tower E is assured at all times when at least three pumps are working at each stage, regardless where they are located in the array of pumps and towers. Tower E can be about 50-ft tall.

The cold-filtered seawater is led through a plurality of flat cooler coils of stainless-steel pipes of 2-in. in diameter approx., for example, which are built into the top half of Tower E, layered about 6-in. apart. In the coils the seawater heats up and, in one greater part, leaves Tower E via stainless pipe line H to feed Boiler I, and in another smaller part, goes out, preferably back to the sea, via stainless pipe G1, as waste water. A servo valve (not shown) makes this flow split on demand. The condensed water leaves Tower E at the bottom as fresh water, in an amount of about 1.2M Gallons per day. At its bottom, Tower E receives via stainless pipe line K2 used steam from five Generators J.

Via pipe line H, the preheated filtered sea water enters to the five Boilers I, where it becomes steam, which feeds five Generators J, via stainless pipe line K1. Heater coils, similar to the cooler coils of tower E (not shown), are operated by approx. 400° F. hot peanut oil flow (just below the smoke point), which heats up the sea water to over 213° F. The excess temperature over this amount depends on the salt concentration of the seawater, which is lower in the deep ocean. In this process, the peanut oil flow cools down by up to 197° F. Every added 58 gr/liter or 58 part/thousand salt raises the water's boiling temperature by about 0.5° C. or 0.9° F.

All vessels and pipes touching inside or out seawater are preferably made of stainless steel, which last for over a decade in ordinary continuous operation. All vessels containing hot liquids (water, sea water or peanut butter oil) are preferably insulated by double walls and/or by encapsulated heat insulation material.

From the Boilers I, brine water is led via stainless pipe line G2 to Desalinator U, from which Salt Y is obtained for consumption.

Steam, via K1 inlet and K2 outlet, flows through Generators J, which produce about 25 kW electricity hourly, which can be fed to the grid or used locally, in part for the plant operation, which includes running pumps, opening and closing valves, mixing biofuel sludge and other incidental actions in need of electrical power, etc. The waste condensate of Generator J is led out as condense water Z, which may be added to effluent line F (connection is not shown).

E, H, I, K1, J, K2, E forms a closed loop of steady seawater-steam flow called the water cycle.

The solar powered peanut oil cycle, formed by I, L1/L2, M, N, O, P, I, is described next.

From the heating coils of the Boilers I, cooled down peanut oil (or another suitable vegetable oil with a similarly high smoke point), via stainless pipes L1, oil is pumped via Pump M to Solar N, where it gets about 400° F. hot, harvesting the concentrated energy of the sun rays.

Overnight, when there is no sunshine, and days with heavy clouds, circuit I, L1, M, N, O, P, I is shorted to I, L2, O, P, I.

In both circuits, shortened or not, the 400° F. hot peanut oil is stored in 5 double-wall stainless Boilers O, which discharges the oil via stainless pipe line P, into Boiler I.

After about a month's use, the hot peanut oil from Boiler O is let out as a sludge via stainless pipe line Q to Breeder R, where it gets transformed by a biochemical process into biofuel, which is discharged from Reactor R to Tank S, where it stored and temporarily harvested via pipeline X. The sludge then is replaced with fresh peanut oil via pipe line V. The Breeder R and Tank S can produce and contains about 17,500-gallon biofuel monthly, for example.

The example photothermal desalination system 100 is controlled electronically (not shown).

Although the features, functions, components, and parts have been described herein in accordance with the teachings of the present disclosure, the scope of coverage of this patent is not limited thereto. On the contrary, this patent covers all embodiments of the teachings of the disclosure that fairly fall within the scope of permissible equivalents.

Many modifications and other implementations of the disclosure set forth herein will be apparent having the benefit of the teachings presented in the foregoing descriptions and the associated drawings. Therefore, it is to be understood that the disclosure is not to be limited to the specific implementations disclosed and that modifications and other implementations are intended to be included within the scope of the appended claims. Although specific terms are employed herein, they are used in a generic and descriptive sense only and not for purposes of limitation.

What is claimed is:

1. A desalination system, comprising:
a seawater harvester configured to harvest seawater from below the ocean thermocline;
at least one heat transfer coil in fluid communication with the seawater harvester and disposed within a containment structure; and
a steam generator configured to provide steam to the containment structure wherein at least some of the provided steam condenses upon interaction with the at least one heat transfer coil to produce fresh water;
wherein the produced fresh water is removed from the containment structure; and
wherein the steam is produced using at least some of the harvested sea water.

2. The desalination system of claim 1, wherein the seawater harvester includes at least one pump.

3. The desalination system of claim 1, wherein the containment structure includes a tower.

4. The desalination system of claim 3, wherein the at least one heat transfer coil is disposed near the top of the tower.

5. The desalination system of claim 3, wherein the steam is input near the bottom of the tower.

6. The desalination system of claim 1, wherein the steam generator uses concentrated solar power to generate the steam.

7. The desalination system of claim, wherein the deep ocean is at least about 500 feet deep.

8. The desalination system of claim, wherein the deep ocean includes water below the ocean thermocline.

9. The desalination system of claim 1, wherein the steam generator includes a boiler.

10. The desalination system of claim 8, wherein the boiler includes at least one heater coil containing heated vegetable oil.

11. The desalination system of claim 9, wherein the vegetable oil is peanut oil.

12. The desalination system of claim 9, wherein the boiler includes a first pipe that permits cooled down vegetable oil to outflow to a concentrated solar power device to produce heated vegetable oil that is received by a second pipe connected to the at least one heater coil.

13. The desalination system of claim 1, wherein the steam generator is further configured to provide steam to an electric generator.

14. The desalination system of claim 12, wherein at least some of the generated electricity is used to power at least one component of the desalination system.

15. The desalination system of claim 12, wherein at least some of the generated electricity is directed to an electrical grid.

16. The desalination system of claim 9, wherein the vegetable oil is stored in insulated containers.

17. The desalination system of claim 9, wherein sludge formed from used vegetable oil is converted to biofuel.

18. The desalination system of claim 11, further including a third pipe that from the boiler that permits brine water to outflow.

19. The desalination system of claim 18, wherein sea salt is produced from the outflowing brine water.

20. The desalination system of claim 18, wherein glycerin is produced from the outflowing brine water.
